(19) United States
(12) Patent Application Publication
(10) Pub. No.: US 2014/0128297 A1
(43) Pub. Date: May 8, 2014

(54) System and Method for Injecting Peracetic Acid

(71) Applicant: Greg A. Conrad, Pocola, OK (US)

(72) Inventor: Greg A. Conrad, Pocola, OK (US)

(21) Appl. No.: 13/671,264

(22) Filed: Nov. 7, 2012

(51) Int. Cl. C09K 8/60; C02F 1/50

(52) U.S. Cl. CPC C09K 8/605; C02F 1/50
USPC 507/267; 210/198.1

(57) ABSTRACT

A method and apparatus for combining multiple sources of intake water for use in hydraulic fracturing and other oil and gas drilling operations and treating the water with peracetic acid prior to discharging into one or more frac tanks or into a well. The apparatus includes a manifold assembly that combines water from multiple sources prior to entering a mixer where PAA is injected in a finely dispersed spray under pressure to thoroughly mix the PAA and intake water prior to be discharged into one or more frac tanks. By using a manifold assembly, the apparatus is easily transported to different job site-locations and permits the use of standard connection fittings to easily connect the apparatus to existing fracturing equipment. A method for injecting the PAA and testing and adjusting the level of PAA is also disclosed.

### CROSS-REFERENCE TO RELATED APPLICATION

This application claims the benefit of U.S. provisional patent application No. 61/556,490 filed Nov. 7, 2011.

### BACKGROUND OF THE INVENTION

1. Field of the Invention

This invention relates to a method and apparatus for injecting peracetic acid into various water supply sources as a clarifying agent to reduce or remove biological contaminants and to increase the pumpability so that the treated water can be used in oil-field operations, particularly in fracturing operations.

2. Description of Related Art

The world's total extractable methane reserve is estimated to be about 900 quadrillion cubic feet. Much of this gas is contained in formations where extraction using conventional vertical or horizontal drilling techniques is possible. However, large amounts of natural gas are found in shale formations, which have low porosity and permeability, making the gas is more difficult to extract. Increasing prices for natural gas combined with the positive environmental aspects of the use of natural gas as a fuel source have resulted in greater demand for advanced drilling technologies in an effort to more efficiently extract and recover natural gas, particularly in shale formations. One technique that has been developed to increase or “stimulate” production in shale formations is hydraulic fracturing. Using this technique, a fracturing fluid is sent down a well (typically a conventional horizontal well) under sufficient pressure to fracture the face of the mineral formation throughout the formation. Fracturing releases the hydrocarbon trapped within the formation and the hydrocarbon may then be extracted through the well. As the pressure on the face of the fractured mineral is released to allow for the extraction of the hydrocarbon fuel, the fracture in the formation would normally close again. However, proppants, such as course sand or sintered bauxite, are often added to the fracturing fluid to hold the fractures open, thereby increasing the effectiveness of the fracturing fluid. The fractures, held open by the proppants, form a channel through which the trapped hydrocarbons may escape after pressure is released. Course fracturing of this type is very successful in horizontal drilling applications and has proven particularly useful in the recovery of shale gas. Similar operations are also applicable for enhanced recovery from sandstone formations with less than 0.1 millidarcy permeability, known as “tight gas sands.”

Water from various sources is commonly used as the primary fluid in fracturing fluids. The operations typically require large amounts of water, which may be supplied from nearby fresh water ponds, lakes and rivers. In some cases produced water (both ground water and recovered injected water) from existing wells in the area may be used as an additional water source. It may be necessary to obtain water from several different sources to have sufficient supply for the fracturing operations.

These water sources typically contain suspended solids, bacteria, or other organic or biological material, which may foul the formation. For example, suspended solids may clog the fractures, bacteria or other organic material that may grow within the formation, and scale may build-up, all of which interfere with the recovery of the natural gas. Additionally, these materials may interfere with the pumpability of the fracturing fluid, which must be pumped at high pressure to effectively create fractures in the formation. When water is drawn from multiple sources, fouling and pumpability problems may be compounded as each water source may have different types or levels of contaminants. Typically, various additives are used with the fracturing fluid to address fouling problems. These include friction reducers, scale inhibitors, and water clarifiers/biocides. One known and effective biocide used with fracturing fluid is peracetic acid (also known as peroxyacetic acid or PAA). For example, U.S. Patent Application Publication No. 2010/0160449 (Ser. No. 12/632,056) discloses a PAA composition and method using the PM composition as a well treatment fluid by simply directing the fluid into a subterranean environment. However, the '056 patent application does not disclose any particular apparatus or methodology for effectively introducing the PAA into the well or the fracturing fluid.

### SUMMARY OF THE INVENTION

The method and apparatus disclosed herein use PAA injection to effectively treat water from various sources to remove or reduce fouling contaminants so that the treated water may be used as a fracturing fluid or otherwise used in oil and gas operations. According to one embodiment of the invention, PAA is injected into the water supply line upstream of the frac tank (or on the intake side of the frac tank), thereby treating the water before introducing any other additives and before introducing the water to either the frac tank or the well. According to another embodiment of the invention, an intake manifold is used to combine multiple sources of water prior to injecting the PAA for treatment. These embodiments have the advantage of allowing maximum time for treatment of the water, which minimizes damage to the formation when the treated water is used as a fracturing fluid. According to another embodiment, an outlet manifold is used to direct the treated water to one or more frac tanks.

In another embodiment of the invention, an injection quill is used to evenly disperse the PAA into the water in a mixer. The configuration of the quill and mixer provide sufficient residence time to thoroughly mix the PAA and water (and begin treating the water) prior to discharge from the mixer. By thoroughly mixing the water with PAA, the water may be more efficiently clarified and treated for fracturing use. Because intake water may come from multiple sources, the volume and level of PAA needed to adequately treat the water will vary at different operation sites and may vary over time at a single operation site. The apparatus of this embodiment is preferably designed so that the injection quill is interchangeable with differently sized and configured quills to permit varying PAA flow rates into the mixer. This permits flexibility in operation to increase or decrease the rate of injection so that the water is effectively treated without use of excess chemicals.

In another embodiment of the invention, a method for injecting PAA into intake water from one or more sources and discharging the treated water to one or more frac tanks is disclosed. The PAA is injected evenly across a mixer with the direction of PAA flow directed substantially opposite the direction of flow of the intake water to aid in thoroughly mixing the PAA and intake water.

In other embodiments, methods for testing the PAA level are provided. Because of the varying levels of fouling agents in different water sources, the PAA demand needs to be determined at the beginning of the process and periodically monitored as the water is being treated by injection of PAA using testing methodologies that include sampling and dosing to determine the amount of PAA to be added to achieve PAA concentrations of 20-60 ppm. Based on the results of these testing methods, the amount of PAA being injected can then be adjusted as necessary throughout the process. This ensures that an adequate amount is used to achieve the desired level of treatment without using more PAA than necessary, which is wasteful and costly and may damage the formation.

These and other features, objects and advantages of the present invention will become better understood from a consideration of the following detailed description of the preferred embodiments and appended claims in conjunction with the drawings. Although the discussion of the preferred embodiment will focus on hydraulic fracturing, it may be understood that the preferred embodiment is applicable to other gas extraction techniques, including without limitation tight sand gas extraction.

### BRIEF DESCRIPTION OF THE DRAWINGS

The system and method of the invention are further described and explained in relation to the following drawings wherein:

FIG. 1 is a side elevation view of one embodiment of an apparatus according to the invention;

FIG. 2 is a cross-sectional view of the PAA control valve and mixer assembly of the embodiment of FIG. 1;

FIG. 2A is a cross-sectional view of a ball used in an embodiment of the PAA control valve of FIG. 2;

FIG. 3 is a simplified process flow diagram illustrating principal parts of another embodiment of a multiple tank apparatus according to the invention;

FIG. 4 is a perspective view of a manifold assembly of an embodiment of the invention;

FIG. 5 is a cross-sectional view of a PAA control valve assembly of an embodiment of the invention;

FIG. 6 is a perspective view of a quill assembly of an embodiment of the invention;

FIG. 6B is a perspective view of a nozzle used in the quill assembly;

FIG. 7 is a cross-sectional, exploded view of the quill assembly of FIG. 7;

FIG. 8 is a partially broken away cross-sectional view of a portion of the manifold assembly of FIG. 4;

FIG. 9 is a perspective view of an alternate embodiment of the manifold assembly of FIG. 4 mounted on a trailer;

FIG. 10 is a plan view of the embodiment of FIG. 9; and

FIG. 11 is a front elevation of the embodiment of FIG. 9.

### DESCRIPTION OF THE PREFERRED EMBODIMENTS

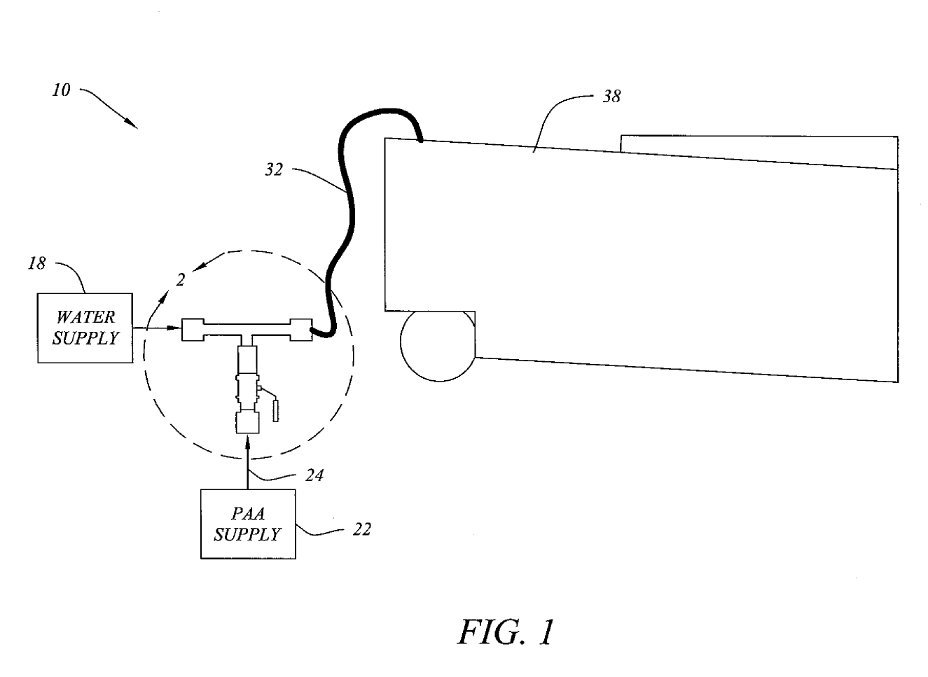

Referring to FIG. 1, one embodiment of a single tank apparatus 10 for injecting PAA is depicted. Water from any source, such as a pond or lake, is pumped to the location of single tank apparatus 10 through water supply line 18. Water enters the PAA mixer and control valve assembly 20, where it is mixed with PAA pumped in from PAA supply tank 22 through PAA supply line 24. Treated water exits the PAA mixer and control valve assembly 20 through treated water discharge line 32 and is stored in frac tank 38 until being pumped into a well as a fracturing fluid. Other additives, such as friction reducers and scale inhibitors and proppants may be added to frac tank 38 using known methods.

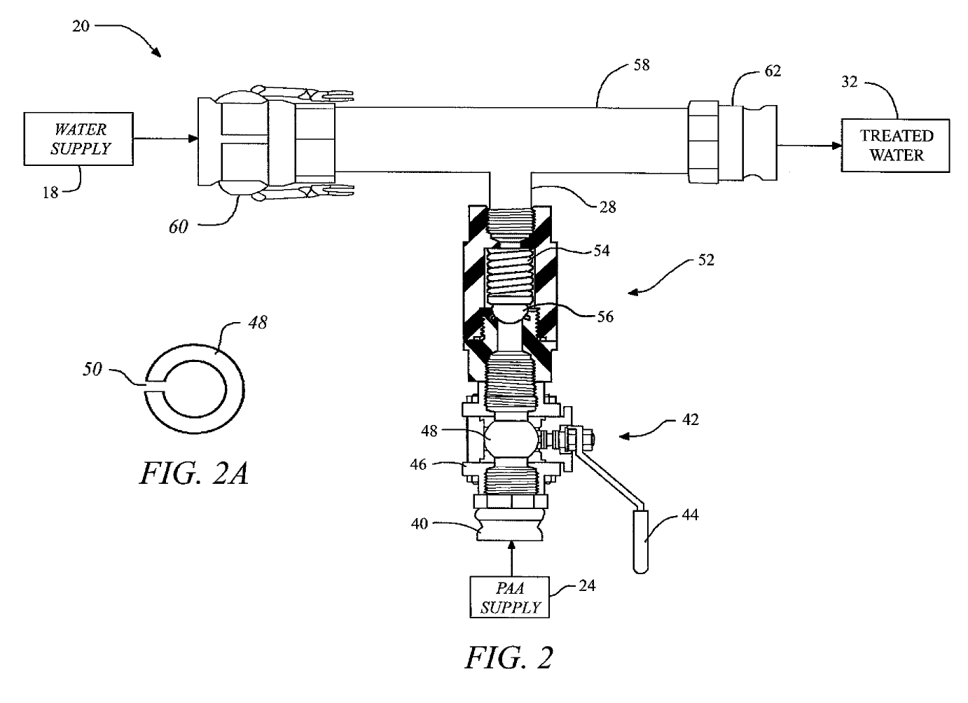

A preferred embodiment of PAA control valve and mixer assembly 20 is depicted in FIG. 2. Connection fittings 60 and 62 connect water supply line 18 and treated water discharge line 32 to assembly 20. Connection fittings 60 and 62 are standard fittings of any type suitable for connecting pipes or hoses together. The use of connection fittings 60 and 62 allow for easy installation of assembly 20 into existing configurations for supplying water to a frac tank, preferably on the water intake side. In an another embodiment, connection fitting 62 may be attached directly to a corresponding fitting on the frac tank 38, allowing treated water to be discharged directly into the frac tank, however, discharge line 32 will typically be used to connect assembly 20 with frac tank 38 (as shown in FIG. 1). A similar connection fitting 40 is providing to connect assembly 20 to PAA supply line 24. A ball valve 42, having a handle 44, housing 46, and ball 48, controls the supply of PAA into assembly 20 through supply line 24. When ball valve 42 is open, PAA is allowed to flow into assembly 20 from a PAA supply tank (not shown). As shown in FIG. 2A, ball 48 is preferably a vented ball, having a vent opening 50 that vents upstream when the valve 42 is closed. Referring again to FIG. 2, after passing through the ball valve 42, the PAA passes through check valve 52. Check valve 52 is preferably a ball-type check valve, having a ball 56 and a spring 54 that cooperate to prevent water and PAA from flowing backward toward ball valve 42. Additionally, check valve 52 is configured so that PAA only flows through check valve 52 and into injection port 28 if sufficient pressure is supplied. PAA is then injected into mixer 58 through injection port 28 under sufficient pressure to thoroughly mix with water from water supply line 18. Ball valve 42 and check valve 52 are standard type valves commonly used in chemical plants and oilfield operations. However, because of the high pressures at which PAA is injected into mixer 58, commercially available check valves may not have a spring 54 with the proper force constant. Accordingly, spring 54 may need to be custom built using methods and materials known to those of ordinary skill in the art. These valves 42 and 52 are connected together and to the PAA supply line 24 and injection port 28 using known connection methods, such as threaded connections or compression fittings. Once the PAA is thoroughly mixed with the water in mixer 58, it is discharged as treated water through discharge line 32.

Preferably, injection port 28 and mixer 58 are made from stainless steel since they are directly in contact with high concentrations of PAA. Alternatively, injection port 28 and mixer 58 may be made of virgin PTFE Teflon or other appropriately strong material. Injection port 28 is preferably the 1 inch diameter size typically used for injection tubes in fracturing operations, although other sizes may be used. Injection port 28 may be detachable from mixer 58 via any suitable connection means, such as a threaded connection. Alternatively, injection port 28 may be permanently attached to or integrally formed with mixer 58.

Check valve 52 is preferably an atomizer type, such that PAA is atomized as it is introduced into mixer 58 through the injection port 28. Alternatively, atomizer nozzles may be incorporated into injection port 28. A fine spray dispersion of the PAA helps facilitate thorough mixing of the PAA and water inside mixer 58 before the water is discharged as treated water through discharge line 32. Additionally, the PAA is preferably injected into mixer 58 at around 300 psi to facilitate mixing. Preferably, mixer 58 is sized to provide sufficient residence time of the water and PAA within the mixer to achieve complete mixing; although it is not necessary that there be sufficient residence time to fully treat the water in the mixer, as the PAA will continue treating the water and acting as a biocide while being stored in frac tank 38. Mixer 58 or discharge line 32 preferably have a standard sample port (not depicted) for obtaining samples of the treated water shortly after the PAA is injected in order to test the PAA level and make adjustments as described below. A sample port or similar device may be used to allow visual inspection of the mixing quality at or near the treated water output. The PAA quality is measured by residual chemical after demand is met. If it appears that the PAA is not being thoroughly mixed with the intake water, then the PAA injection pressure may be adjusted to increase mixing.

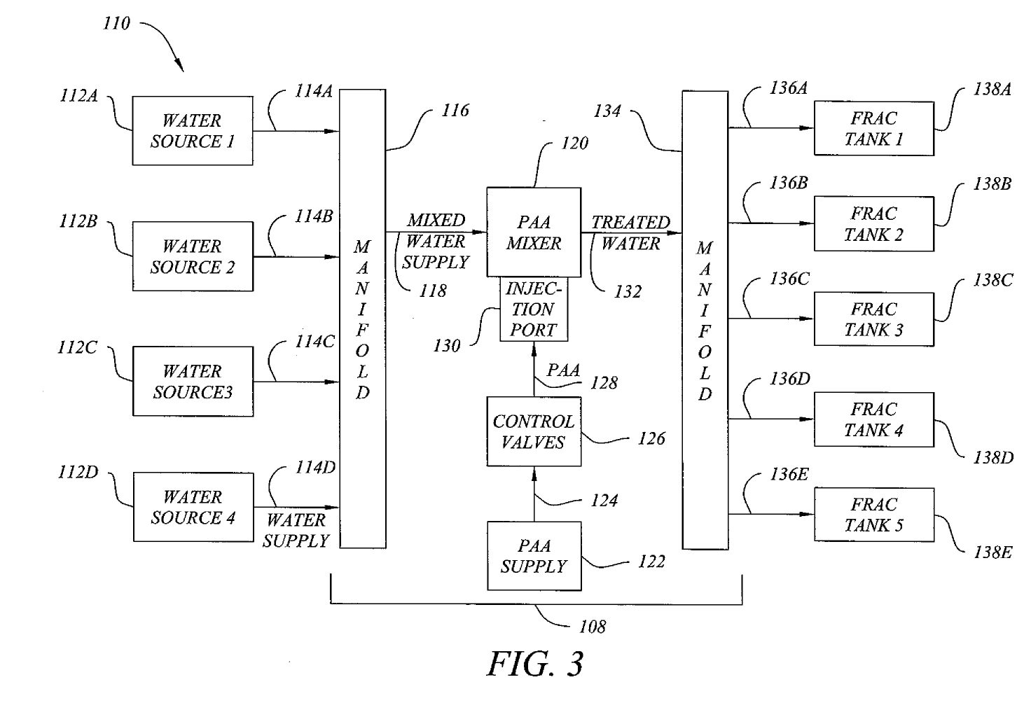

A simplified diagram of another preferred embodiment for a multiple tank apparatus 110 is shown in FIG. 3. Apparatus 110 is similar to apparatus 10, except that it is configured to receive water from multiple water sources 112a-112d (such as ponds, lakes, or production water or from intermediate storage tanks holding water from such sources) and to discharge to multiple frac tanks 138a-138e. Water from all of the sources is pumped through water supply lines 114a-114d into inlet manifold 116 (which is preferably configured to receive water from at least four sources, but not all inlets on manifold 116 must be used and it may be configured for more than four water sources), where they are mixed together before being discharged through mixed water supply line 118. Mixed water from supply line 118 feeds into PAA mixer 120, where it is mixed with PAA from PAA supply tank 122 (which may be a simple chemical drum or barrel). PAA is pumped from PAA supply tank 122, through supply line 124, through control valve assembly 126, through supply line 128 and injection port 130 into mixer 120. Treated water is discharged from mixer 120 through treated water discharge line 138 and into outlet manifold 134. Outlet manifold is preferably configured to discharge to at least five discharge lines, 136a-136e, but not all outlets on outlet manifold must be used and it may be configured for more than five discharge lines. Each discharge line supplies treated water to one or more frac tanks 138a-138e.

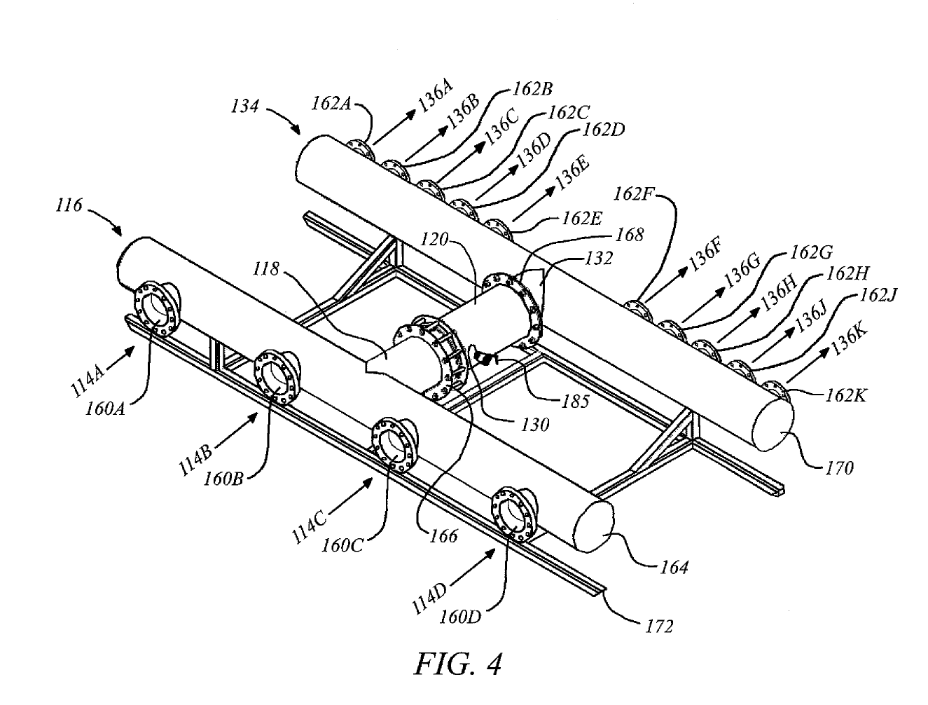

Referring to FIG. 4, a preferred embodiment for manifold assembly 108 of apparatus 110 is shown. Water supply lines 114a-114d supply water from various sources to inlet ports 160a-160d on intake manifold 116. Any standard connections type, such as threaded connectors, may be used to connect water supply lines 114a-114d and inlet ports 160a-160d. Preferably, inlet ports 160 are designed to be sealed using known methods when not connected to a supply line 114. This allows intake manifold 116 to be used when water is being supplied from fewer water sources 112 than the total number of inlet ports 160. Water from the various sources is then mixed inside intake tube 164 and discharged through mixed water line 118. Flange 166 connects mixed water line 118 to PAA mixer 120, where the water is mixed with PAA and discharged through treated water line 132, connected to PAA mixer by flange 168. Any suitable means of connection may be used to connect water lines 118 and 132 to PAA mixer 120. Mixer 120 or discharge line 132 preferably have a standard sample port (not depicted) for obtaining samples of the treated water shortly after the PAA is injected in order to test the PAA level and make adjustments as described below. A sample port or similar device may be used to allow visual inspection of the mixing quality at or near the treated water output. The PM quality is measured by residual chemical after demand is met. If it appears that the PM is not being thoroughly mixed with the intake water, then the PAA injection pressure may be adjusted to increase mixing.

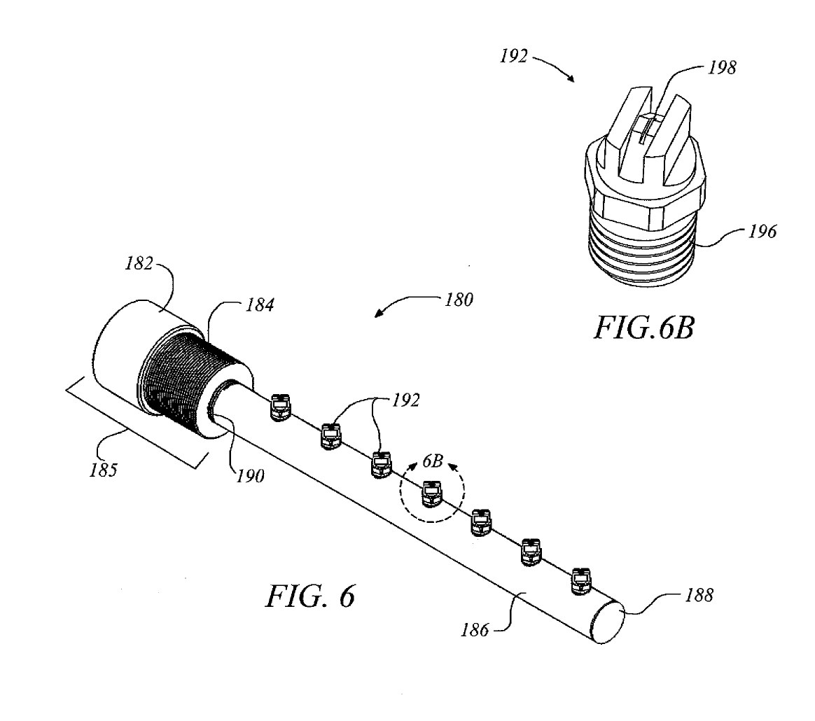

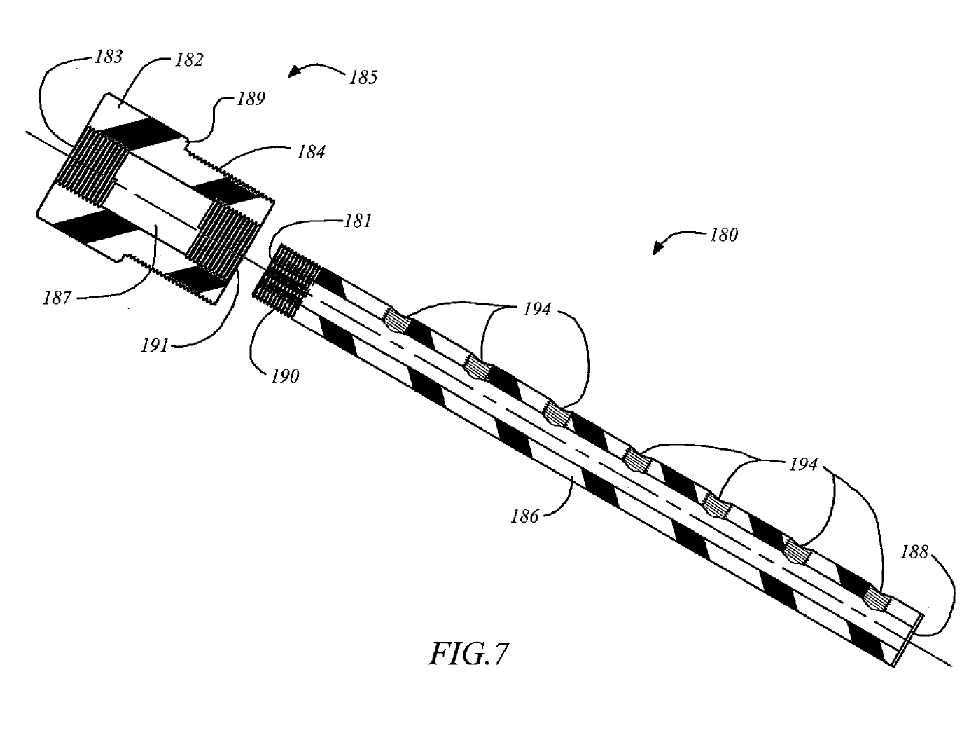

PAA is supplied to PAA mixer 120 through injection port 130, which is preferably a threaded aperture in the side of PM mixer through which an injection quill (discussed below in reference to FIGS. 6-7) is inserted and held in place by quill adapter 185. Because mixer 120 is in direct contact with high concentrations PM, it is preferably constructed of stainless steel. Other parts of the manifold assembly 108 may be made of PVC, carbon steel or other suitable materials.

Once mixed in mixer 120, treated water then flows through treated water line 132 and outlet tube 170 of outlet manifold 134, where it is discharged to discharge lines 136a-136k through outlet ports 162a-162k. As with inlet ports 160, outlet ports 162 are preferably designed to be sealed when not connected to a discharge line 136. This allows outlet manifold 134 to be used when treated water is being supplied to fewer frac tanks 138 than the total number of outlet ports 162. Manifold assembly 108 is preferably mounted on a frame 172, which may then be mounted onto a trailer or flatbed truck, allowing the manifold assembly 108 to be moved to various locations where water treatment for fracturing operations is needed. The control valve assembly 126 (discussed below) and PAA supply tank 122 may also be mounted onto or otherwise secured on the same trailer or flat-bed truck for transport to job-site locations, or these may be separately transported or maintained on-site.

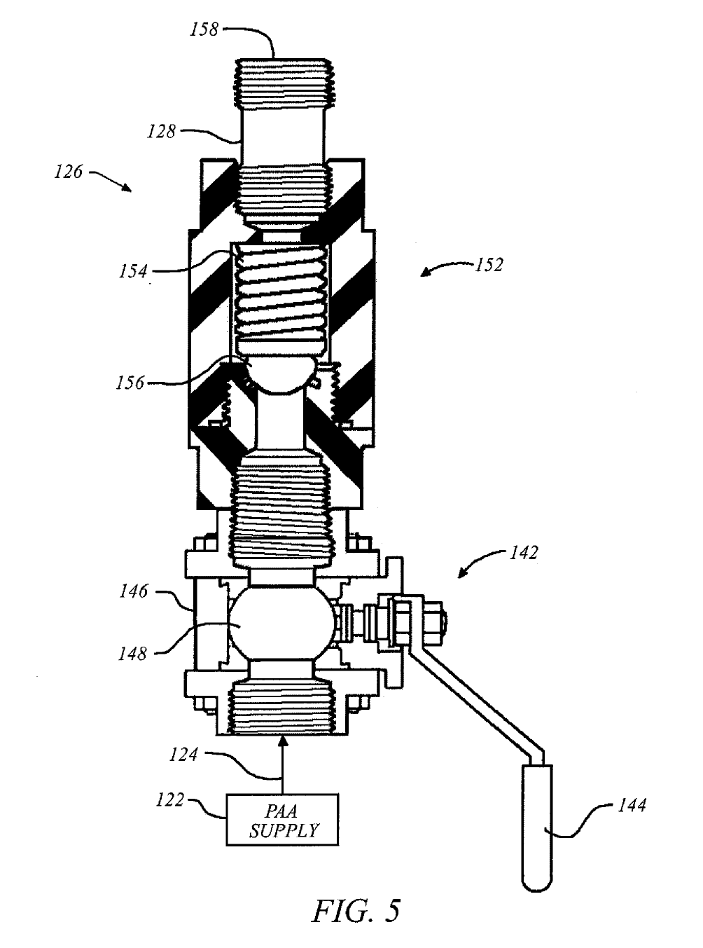

A preferred embodiment for control valve assembly 126 is depicted in FIG. 5. Control valve assembly preferably includes ball valve 142, having handle 144, housing 146, and handle 148, and check valve 152, having spring 154 and ball 156. As with ball valve 42, ball 148 is preferably a vented ball, venting upstream when the valve 142 is closed. Check valve 152 is a back-flow prevention valve similar to check valve 52, although in this preferred embodiment an injection quill is used to atomize the PAA, so the check valve 152 does not need to be an atomizer type valve. Ball valve 142 and check valve 152 are standard type valves commonly used in chemical plants and oilfield operations. However, because of the high pressures at which PAA is injected into mixer 120, commercially available check valves may not have a spring 154 with the proper force constant. Accordingly, spring 154 may need to be custom built using methods and materials known to those of ordinary skill in the art. These valves 142 and 152 are connected together and to the PAA supply lines 124 and 128 using known connection methods, such as threaded connections or compression fittings. PAA supply line 128 has a threaded connector 158 that is designed to fit with internal threads 183 on PAA-quill connector 182 (shown on FIGS. 4 and 7), to permit flow of PAA into PAA mixer 120.

FIGS. 6, 6B, and 7 depict a preferred embodiment for injection quill 180 for use with apparatus 110. Injection quill 180 preferably includes an adapter 185, a quill injection arm 186, nozzle openings 194, and interchangeable nozzles 192. Adapter 185 allows quill arm 186 to be connected to PAA supply line 128 and for quill 180 to be connected to PAA mixer 120. Adapter 185 preferably includes generally cylindrical FAA-quill connector 182, having internal threads 183 and 191 separated by a central bore 187 and having two open ends allowing PAA to freely flow through the adapter from PAA supply line 128 and into quill arm 196. Threaded connector 158 on supply line 128 fits with internal threads 183. Internal threads 191 fit with external threads 190 on quill arm 186, allowing different quill arm configurations and sizes to be easily used and interchanged. Adapter 185 also has external threads 184 on the end having internal threads 191. External threads 184 are designed to fit with the threaded aperture of injection port 130 on PAA mixer 120, allowing quill 180 to be releasably attached to PAA mixer 120. External threads 184 preferably extend from the end of adapter 185 to shoulder 189, which rests against the exterior side of PAA mixer 120 when quill 180 is attached to PAA mixer 120.

Quill arm 186 is preferably cylindrical, having an outside diameter of 1-2 inches, with an open end 181, a sealed end 188, and a series of nozzle ports 194 connecting to an open central bore extending along the longitudinal axis of quill arm 186. Nozzle ports 194 are preferably threaded apertures in one side of quill arm 186, with the threads being configured to receive threads 196 on nozzle 192. Nozzles 192 are preferably aligned along one side of quill arm 186 in a configuration allowing flow of PAA through the nozzles in a direction that is substantially perpendicular to the longitudinal axis of quill arm 186; however, it may be desirable to have nozzles 192 that direct PAA flow at an another angle relative to quill arm 186 or to have nozzles 192 misaligned relative to each other and any other configuration may be used. Nozzles 192 may be any commercially available nozzles suitable for injection of PAA under high pressure, most preferably around 300 psi or greater. It is preferred that the PAA is atomized upon injection through nozzle opening 198 into mixer 120 so that it is evenly dispersed and can be thoroughly mixed with the intake water inside mixer 120. Different nozzles 192 may have different sized or shaped nozzle openings 198. A different sized nozzle opening 198 may be needed to permit various volumes of PAA discharge depending on the volume of intake water being used. Varying volumes of PAA discharge may also be needed depending on the level of chemical demand of the water sources. Quill 180 is preferably designed to permit interchangeability of various parts to accommodate the particular needs of a fracturing operation and the level of treatment needed for particular water sources. Additionally, the pressure at which the PAA is introduced into mixer 120 may be varied, such as by adjusting the ball valve 142, as needed to achieve full mixing of the PAA and intake water and to achieve a desired concentration of PAA in the treated water. The methods according to the invention for testing the PAA level and making such adjustments are discussed below.

Since it is most desirable to not have to change out PAA mixer 120, the size and configuration of any of several parts, such as threads 183, 190, and 191, quill arm 186, nozzle ports 194/nozzles 192 and nozzle openings 198 can all be modified as needed, provided that adapter 185 and external threads 184 remain sized and configured for connection with injection port 130. Multiple quill arms 186, having different sizes and different nozzles 192 are preferably included as part of apparatus 110, so that they can be quickly changed out as needed on the job site. An injection quill similar to injection quill 180 may also be used with single tank apparatus 10, with suitable modifications that will be understood by those of ordinary skill in the art.

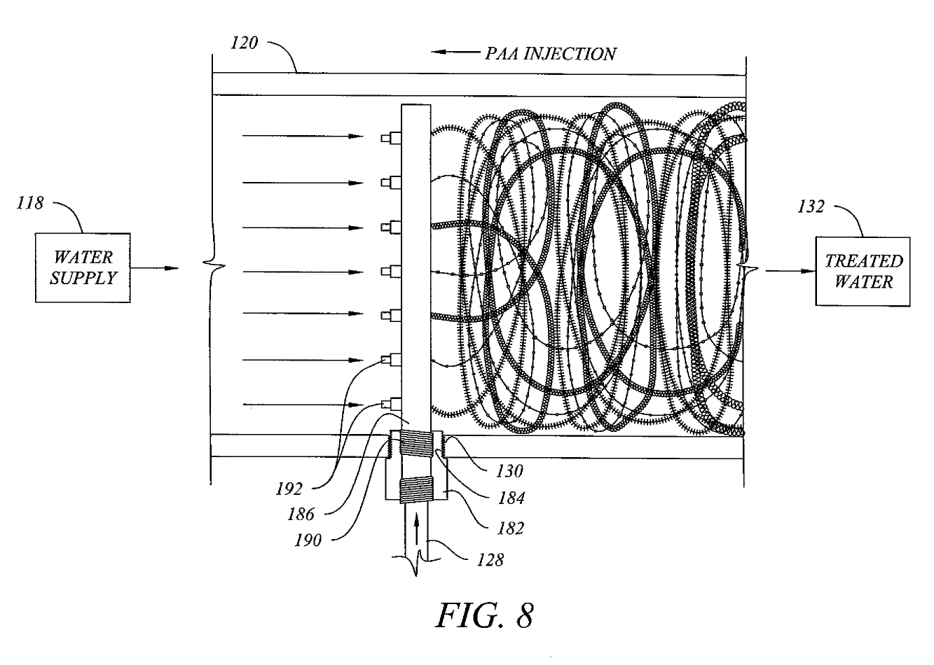

FIG. 8 depicts a partial cross-sectional view of a preferred embodiment for insertion of quill 180 into PAA mixer 120. Quill arm 186 is inserted into PAA mixer 120 in an orientation substantially transverse to the direction of water flow from mixed water supply line 118. Quill arm, which is preferably around 12-18 inches long, extends almost all the way across the diameter of PAA mixer 120 along a substantially central axis. Nozzles 192 are preferably aligned facing upstream relative to the direction of water flow. PAA is injected under pressure into mixer 120 through nozzle openings 198 as an atomized, fine mist to fully disperse and mix with the mixed water intake. FIG. 8 depicts a preferred mixing pattern achieved with the preferred quill and nozzle configuration, but the use of other configurations may result in other mixing patterns. Preferably, mixer 120 is sized to provide sufficient residence time of the water and PAA within the mixer to achieve complete mixing; although it is not necessary that there be sufficient residence time to fully treat the water in the mixer, as the PAA will continue treating the water and acting as a biocide while being stored in one or more frac tanks 138. Thus, as the fluid exits PAA mixer 120 through treated water line 132, the PAA is fully mixed in with the water. If testing or observation indicate that the PAA is not fully mixed or is not in a desired concentration, according to the methods of the invention discussed below, then adjustments may be made to the volume of PAA or pressure of discharge into mixer 120 to achieve full mixing and desired concentrations.

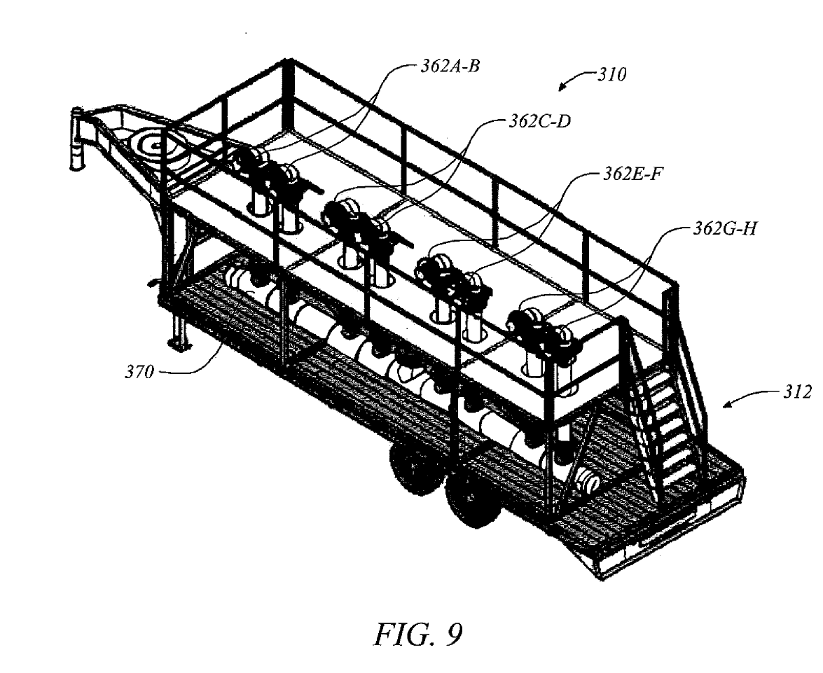

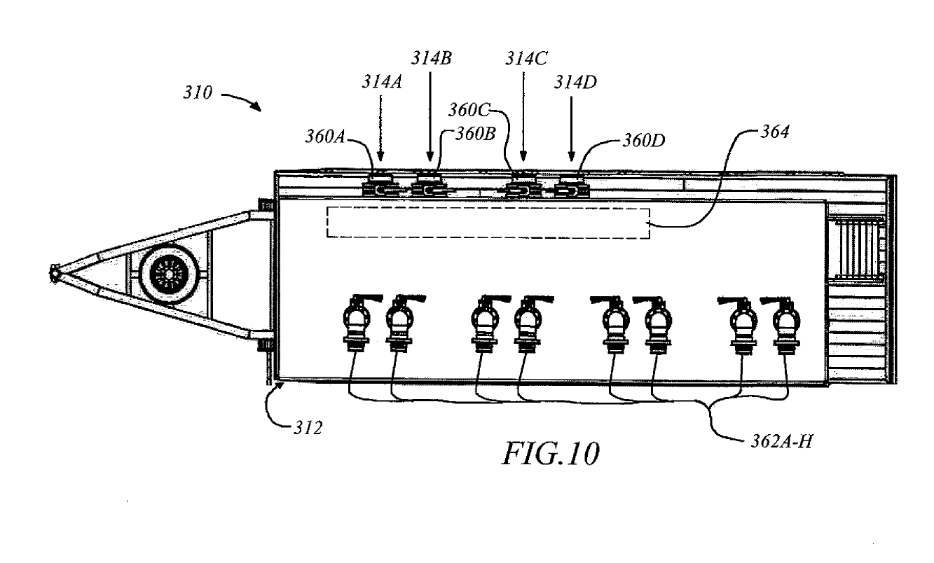

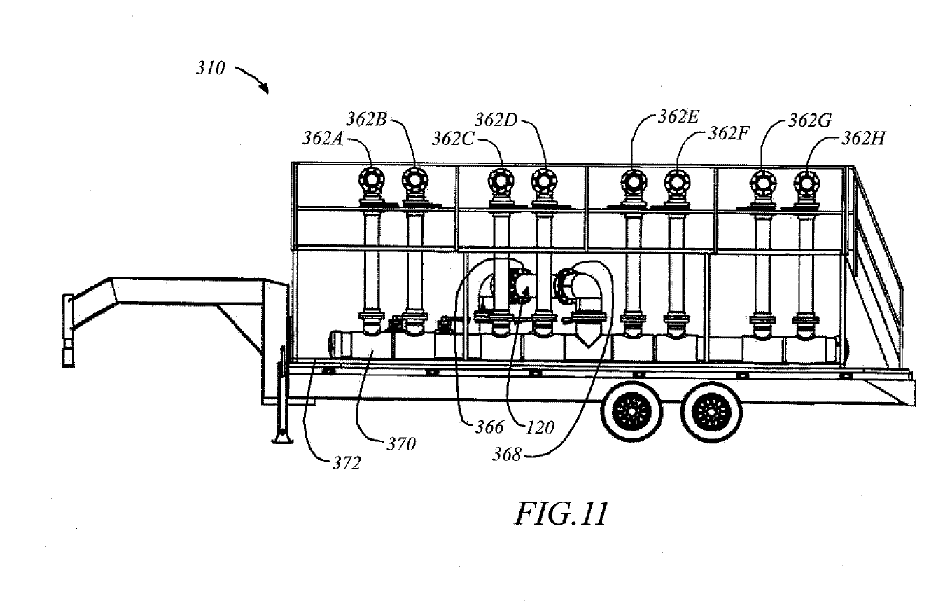

Another embodiment for a multiple tank apparatus 310 is depicted in FIGS. 9-11. Apparatus 310 is shown mounted on a flat-bed trailer 312 allowing it to be easily transported from one job site to another. Apparatus 310 is similar to apparatus 110 except that the outlet ports 362a-h are configured to be elevated relative to the inlet ports 360a-d so that they are substantially at the same height as the top of a typical frac tank. Most frac tanks are designed to accept intake water at an elevated position on the tank (such as that depicted on FIG. 1). The configuration of apparatus 310 allows the use of a raised platform 316 to access the outlet ports 362, which may be desirable as a safety feature when workers need to make connections from the outlet ports 362 to an elevated access point on the frac tank. Apparatus 310 also includes intake ports 360a-d to receive water from various sources through water supply lines 314a-d, an intake tube 364 for mixing water from the various sources, PAA mixer 120 configured to be connected with control valve assembly 126, outlet tube 370, and manifold frame 372. Other than the elevated positioning of outlet ports 362, the configuration and elements of these parts are preferably the same as the corresponding parts for apparatus 110.

According to another embodiment, a method is provided for injecting PAA into water to be used as a frac fluid including the following steps: (1) if intake water from more than one source is being used, mixing intake water from all sources; (2) pumping intake water into a mixer; (3) injecting a sufficient amount of PAA into mixer, preferably using a finely dispersed spray under pressure to achieve thorough mixing with the intake water and to achieve a PAA concentration between 20-60 ppm immediately after mixing; (4) discharging treated water from the mixer to one or more frac tanks. According to this method it is preferred that the PAA be injected in the mixer at substantially equidistant locations across the diameter (or other dimension transverse to the direction of intake water flow) of the mixer. The PAA is preferably atomized upon injection into mixer, so the injection is multi-directional; however, it is preferred that the PAA be injected in a direction substantially upstream relative to the direction of intake water flow to aid in mixing of the PAA and intake water. As described above, adequate mixing may be tested by visual inspection and the injection pressure adjusted to increase mixing as necessary.

According to other embodiments, methods for initially testing and periodically re-testing the level of PAA in the treated water and the consistency of mixing is provided so that adjustments can be made as necessary. These testing methods can be easily done in the field, at the job-site. A preferred method for testing the water and adjusting the amount of PAA includes the following steps: (1) collect a representative sample of the water source(s) that will be used in the operation (preferably the water sources used will be at least 70% fresh waters and no more than 30% produced waters); (2) divide the sample into several containers (such as beakers) of a known volume (such as 1 liter or 1 gallon); (3) using a pipette, or other measuring device, dose in a known quantity of PAA into each container; (4) thoroughly mix the samples in each container; (5) following the directions in a commercially available PAA test kit (or using commercially available PAA test strips) measure the concentration in each sample container within approximately 5 minutes of dosing with PAA; (6) if the concentration is below 20 ppm, immediately re-dose with a known quantity of PAA and re-test until PAA levels are in the range of 20-60 ppm 7) repeat steps (1)-(6) on a fresh sample using the total volume of PAA determined in steps (3)-(6) to verify the volume of PAA is sufficient to achieve a concentration of 20-60 ppm. The amount of PAA added to the samples in step 3 is typically between 0.33 gpt (gallons per thousand gallons of water) to 2.94 gpt, depending on the ratio of fresh water sources to produced water sources being used (a higher gpt is needed for higher levels of produced waters). The PAA concentration in the test sample (and in the resulting treated water during operation) will drop over time, which is normal and expected and why testing within a short time of dosing is important. A preferred dosing level is determined based on the quantity of PAA that will give about 20-60 ppm residual PAA immediately after dosing. The amount of PAA needed in operation is then scaled up from the testing dose level to correspond to the volume of intake water that will be treated.

It is also important to periodically test the treated water to determine the adequacy of PAA injection, so that adjustments may be made as necessary. According to another embodiment of the invention, a preferred method for such testing includes collecting a representative sample of the treated water, preferably from a sampling port located between mixer 58 and frac tank 38 when using apparatus 10 or preferably between mixer 120 and outlet tube 170 or 370 when using apparatus 110 or 310. The representative sample is tested according to steps (2)-(7) above until the level of PM is between 20-60 ppm residual. If necessary, the amount of PAA injected into mixer 58 or 120 is adjusted to an amount corresponding with the dosing amount (adjusted for the amount of intake water being treated relative to the sample size) that was necessary to achieve a PAA concentration of 20-60 ppm. This testing procedure is preferably repeated every 10 minutes, with the results recorded and necessary adjustments made each time.

The use of certain equipment, such as pumps, a PM supply tank, intermediate storage tanks for intake water, and flow meters that are commonly used in oil-field and chemical operations and are well known to those of ordinary skill in the art, may be used in connection with the present invention. Additionally, testing of the PM concentration and level of mixing are performed manually or by visual inspection in the preferred embodiments described herein; however, automated testing and the use of electronic testing or sensing equipment, such as described in U.S. Pat. No. 8,226,832, may also be used with modifications that would be understood by those of ordinary skill in the art. Those of ordinary skill in the art will also appreciate upon reading this specification and the description of preferred embodiments herein that modifications and alterations to the apparatus and methods may be made within the scope of the invention and it is intended that the scope of the invention disclosed herein be limited only by the broadest interpretation of the appended claims to which the inventor is legally entitled.

I claim:

1. A PAA mixing apparatus comprising:
at least one connection for receiving intake water from one or more water sources and supplying intake water to a mixer;
an injection port for injecting PAA into the mixer to mix with the intake water;
a control valve assembly for controlling the flow of PAA; and
a discharge line for discharging treated water from the mixer for use in oil and gas drilling operations.

2. The PAA mixing apparatus according to claim 1 further comprising an injection quill to disperse the PAA within the mixer, wherein the injection quill is releasably connected to the injection port.

3. The PAA mixing apparatus according to claim 2 wherein the injection quill is inserted into the mixer so that the longitudinal axis of the quill is perpendicular to the direction of intake water flow.

4. The PAA mixing apparatus according to claim 2 wherein the injection quill comprises a quill arm and one or more nozzle ports configured to releasably engage with various types of nozzles.

5. The PAA mixing apparatus according to claim 4 further comprising a nozzle for each nozzle port, wherein each nozzle is configured to atomize the PAA injected into the mixer.

6. The PAA mixing apparatus according to claim 4 further comprising one or more sets of nozzles, each of which are interchangeably engageable with the nozzle ports to adjust the parameters of PAA injection within the mixer.

7. The PAA mixing apparatus according to claim 5 wherein the nozzles are oriented in a direction substantially upstream relative to the direction of flow of the intake water.

8. The PAA mixing apparatus according to claim 1 further comprising multiple injection quills of varying configurations, each interchangeable and releasably connectable to the injection port.

9. The PAA mixing apparatus according to claim 1 wherein the discharge line is connected to a frac tank.

10. The PAA mixing apparatus according to claim 1 further comprising an outlet manifold connected to the discharge line, wherein the outlet manifold comprises multiple outlet ports for discharging treated water to one or more frac tanks.

11. A method for injecting PAA comprising the following steps:
pumping intake water into a mixer;
injecting a sufficient amount of PAA into the mixer to treat the intake water;
discharging treated water from the mixer to one or more storage tanks;
pumping the treated water from the one or more storage tanks for injection into a well.

12. The method according to claim 11 further comprising using intake water from more than one source and mixing the intake water from more than one source together prior to pumping into the mixer.

13. The method according to claim 11 wherein the PAA is injected in an amount sufficient to achieve a concentration of 20-60 ppm.

14. The method according to claim 11 wherein the PAA is injected under pressure in a finely dispersed spray to mix with the intake water.

15. The method of claim 11 further comprising the following steps prior to pumping the intake water into the mixer:
obtaining a sample of the intake water;
dosing the sample with an amount of PAA between about 0.3 and 3 gpt based on the sample size;
measuring the concentration of PAA in the sample;
if the first measurement is less than 20 ppm, repeat the dosing and measuring steps until a concentration between 20 and 60 ppm is obtained;
calculating the amount of PAA needed to be injected based on the total amount of PAA dosing in the sample, scaled to the amount of intake water that will be pumped.

16. The method according to claim 15 wherein intake water from multiple sources is used and the sample is a mixture from all the water sources.

17. The method according to claim 15 further comprising the step of verifying the total dose prior to the calculating step by obtaining a fresh sample of intake water and repeating the dosing and measuring steps to ensure the concentration of PAA is between 20 and 60 ppm.

18. The method according to claim 15 further comprising the following steps prior to pumping the treated water:
obtaining a sample of the treated water;
dosing the sample with an amount of PAA between about 0.3 and 3 gpt based on the sample size;
measuring the concentration of PAA in the sample;
if the first measurement is less than 20 ppm, repeat the dosing and measuring steps until a concentration between 20 and 60 ppm is obtained;
calculating the amount of PAA needed to be injected based on the total amount of PAA dosing in the sample, scaled to the amount of intake water that is being pumped; and
adjusting the PAA injection to correspond with the calculated amount.

19. The method according to claim 18 wherein the steps are repeated approximately every 10 minutes while intake water is being pumped into the mixer.

20. The method according to claim 18 further comprising the steps of inspecting the treated water to determine if the PAA is thoroughly mixing with the intake water and adjusting the PAA injection to increase mixing if needed.

21. The method according to claim 11 wherein the PAA is injected into the mixer in a substantially upstream direction relative to the direction of flow of the intake water.
